(19) United States
(12) Patent Application Publication
(10) Pub. No.: US 2006/0036459 A1
(43) Pub. Date: Feb. 16, 2006

(54) User configurable one click punchout tracking

(75) Inventors: Anish Harshadbhai Desai, Castro Valley, CA (US); Saverio D. Ferme, Belmont, CA (US); Sabrina Xuan Feng, San Jose, CA (US)

Correspondence Address: TOWNSEND AND TOWNSEND AND CREW LLP, TWO EMBARCADERO CENTER, 8TH FLOOR, SAN FRANCISCO, CA, 94111-3834, US

(73) Assignee: Oracle International Corporation, Redwood City, CA (US)

(21) Appl. No.: 11/016,154

(22) Filed: Dec. 17, 2004

Related U.S. Application Data
(60) Provisional application No. 60/600,931, filed on Aug. 11, 2004.

(51) Int. Cl. G05B 19/418

(52) U.S. Cl. 705/1; 705/8

(57) ABSTRACT

Techniques for tracking shipments of items are provided. A graphical user interface is provided for setting up a tracking service for a carrier. A tracking service may be set up for any number of carriers. Website access information is then received for the carrier. The website access information includes any information needed to access a carrier's shipment tracking service on their website. For example, a user may determine website access information for the carrier and input the information into the interface. Parameters for the website access information are also received. The website access information and the parameters for the carrier tracking service are then stored. The website access information and parameters may then be used to automatically access tracking information for a shipment for the carrier.

### CROSS-REFERENCES TO RELATED APPLICATIONS

This application claims priority from co-pending U.S. Provisional Patent Application No. 60/600,931, filed Aug. 11, 2004, entitled “User Configurable One Click Punchout Tracking”, which is hereby incorporated by reference, as if set forth in full in this document, for all purposes.

### BACKGROUND OF THE INVENTION

The present invention generally relates to tracking shipments and more specifically to techniques for automatically providing access to shipment tracking information for third party websites.

In order to track shipments, users typically go to an individual carrier's website and enter a unique tracking number to track their shipments. This process is not intuitive and a user needs to remember a lot of information in order to track a shipment. For example, information such as how to log onto the carrier's website, tracking numbers to input, and how to get to a tracking page on a carrier's website, is needed in order to track a shipment. This solution is not practical for business users that have a large volume of shipments.

Software applications are provided that track shipments from carrier websites as part of business applications. These solutions, however, are inflexible and only allow users to track shipments for one or two carriers' websites. Tracking programs for these business applications are hard coded specifically for the one or two carriers' websites. Accordingly, only shipments from these one or two carriers' websites can be tracked. Also, any changes to the carriers' website for shipment tracking required programmatic changes to the business application. Thus, a user needed to re-program the business application. This expertise is not readily known by users of the business applications. Additionally, support for new carriers could not be provided without programmatic changes to the application. Thus, the above solution is not practical for business users in addition to costing a lot of money to maintain, customize, and operate.

### BRIEF SUMMARY OF THE INVENTION

Embodiments of the present invention generally relate to tracking shipments.

In one embodiment, a method for tracking shipments of items is provided. A graphical user interface is provided for setting up a tracking service for a carrier. A tracking service may be set up for any number of carriers. Website access information is then received for the carrier. The website access information includes any information needed to access a carrier's shipment tracking service on their website. For example, a user may determine website access information for the carrier and input the information into the interface. Parameters for the website access information are also received. The website access information and the parameters for the carrier tracking service are then stored. The website access information and parameters may then be used to automatically access tracking information for a shipment for the carrier.

In another embodiment, a method for requesting tracking information for a shipment is provided. A request for tracking status information for a shipment associated with a carrier is received. A tracking service with the carrier may be set up using the method provided above. Website access information for the carrier and parameters are determined for the carrier's tracking service. A request using the website access information, the parameters, and identification information for the shipment is then generated. The request is sent and tracking status information is received in response to sending the request.

In one embodiment, a method for tracking deliveries of items is provided. The method comprises: providing an interface for setting up a tracking service for a carrier; receiving website access information for a website for the carrier; receiving parameters for the website access information; and storing the website access information and the parameters for the carrier tracking service, wherein the website access information and the parameters are used to automatically access tracking information for a shipment for the carrier's website.

In another embodiment, a method for requesting tracking information is provided. The method comprises: (a) receiving a request for tracking status information for a shipment associated with a carrier; (b) determining website access information for a website of the carrier; (c) determining one or more parameters for the website access information; (d) generating a request for the website access information using the one or more parameters and information for the shipment; (e) sending the request to the carrier's website; and (f) receiving tracking status information in response to sending the request.

A further understanding of the nature and the advantages of the inventions disclosed herein may be realized by reference of the remaining portions of the specification and the attached drawings.

### BRIEF DESCRIPTION OF THE DRAWINGS

FIG. 1 depicts a system for tracking shipments according to one embodiment of the present invention.

FIG. 2 depicts a simplified flowchart of a method for setting up a tracking service for a carrier according to one embodiment of the present invention.

FIG. 3 depicts a simplified flowchart of a method for requesting tracking status information using shipment tracker according to one embodiment of the present invention.

FIG. 4 depicts a graphical user interface for providing information for website access information according to one embodiment of the present invention.

FIG. 5 depicts a graphical user interface that may be provided by shipment tracker 104 according to one embodiment of the present invention.

FIG. 6 depicts a graphical user interface that shows a summary of tracking services that have been set up according to one embodiment of the present invention.

FIG. 7 depicts a graphical user interface that may be used to send a request for tracking a shipment according to one embodiment of the present invention.

FIG. 8 shows a graphical user interface that depicts tracking status information that is received from the carrier's website according to one embodiment of the present invention.

FIG. 9 is a simplified block diagram of a computer system according to an embodiment of the present invention.

### DETAILED DESCRIPTION OF THE INVENTION

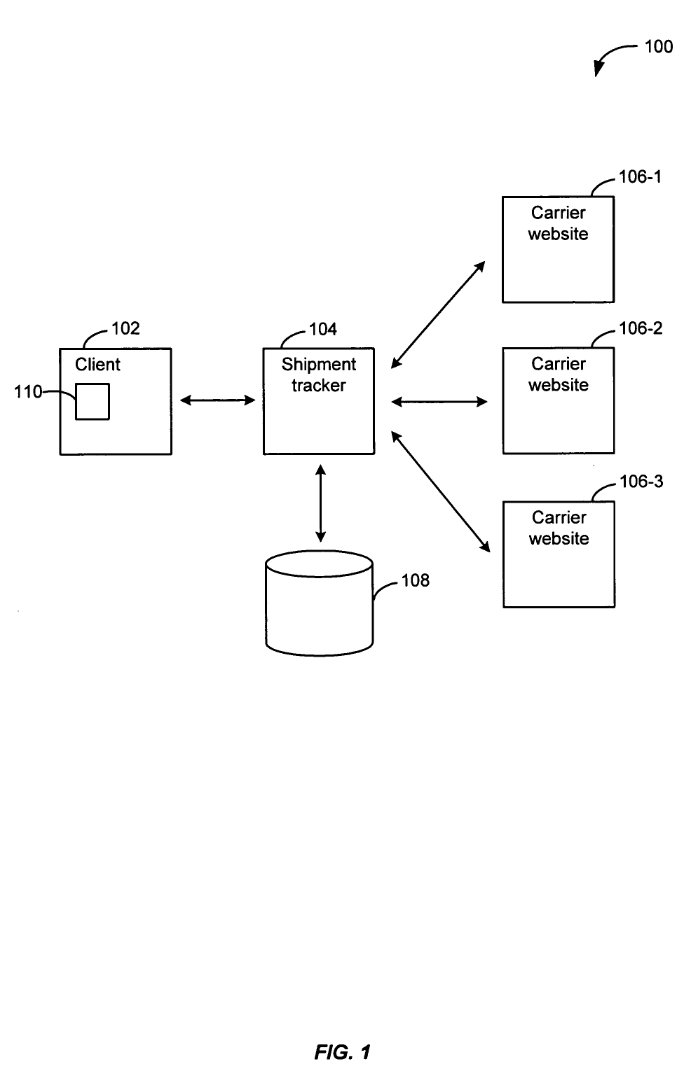

FIG. 1 depicts a system 100 for tracking shipments according to one embodiment of the present invention. System 100 includes a client 102, shipment tracker 104, one or more carrier websites 106, a database 108, and an interface 110.

Client 102 may be any computing device capable of communicating with shipment tracker 104. For example, client 102 may be a personal computer, workstation, personal digital assistant (a PDA), pocket PC, laptop computer, etc. Client 102 includes an interface 110 for communication with shipment tracker 104. Interface 110 allows the user to set up a tracking service for a carrier and also to request tracking status for shipments for a carrier. It will be understood that any number of clients 102 may communicate with shipment tracker 104.

Shipment tracker 104 is configured to interact with carrier websites 106 in order to check the status of shipment. A shipment may be any shipment of items through a service. For example, a shipment may be for one or more goods using a service, such as the United Parcel Service (UPS). Requests for tracking status from interface 110 may be received at shipment tracker 104. Shipment tracker 104 then requests tracking status information from carrier websites 106.

The request may be performed using information stored in database 108. For example, tracking identifiers, website access information, and parameters may be stored in database 108. Tracking identifiers, such as tracking numbers, may be any information that is unique to a shipment. For example, a tracking identifier may be a unique tracking number for a shipment.

Shipment tracker 104 also enables the user to set up a tracking service for a carrier's website 106. In one embodiment, this process may be performed without a user performing any programming. For example, information that is needed from a carrier's website 106 is input into interface 110. Shipment tracker 104 then uses the information to automatically access a carrier's website 106 for tracking status information. A user may use interface 110 to set up tracking services for any number of carriers' websites 106.

Carrier website 106 may be any website that allows a user to check tracking status information for a shipment. For example, United Parcel Service (UPS) provides a webpage where a tracking number may be entered into a form provided on the webpage. Tracking status information is then provided. Tracking status information may be any information that indicates the status of a shipment for tracking information. For example, a package may be shipped from San Francisco to Chicago through Denver. The tracking status information may indicate where the package is in the shipment, such as in Denver. This tracking status information may also indicate when the package will arrive at its destination in Chicago.

The tracking status webpage requires certain information. This information may be determined by a user. For example, certain html commands are required to access the tracking status information for the webpage. This information will be described in more detail below.

In one embodiment, client 102, shipment tracker 104, and carrier website 106 may communicate through any communication means. For example, they may communicate through the Internet, a wireless network, a wire line network, etc.

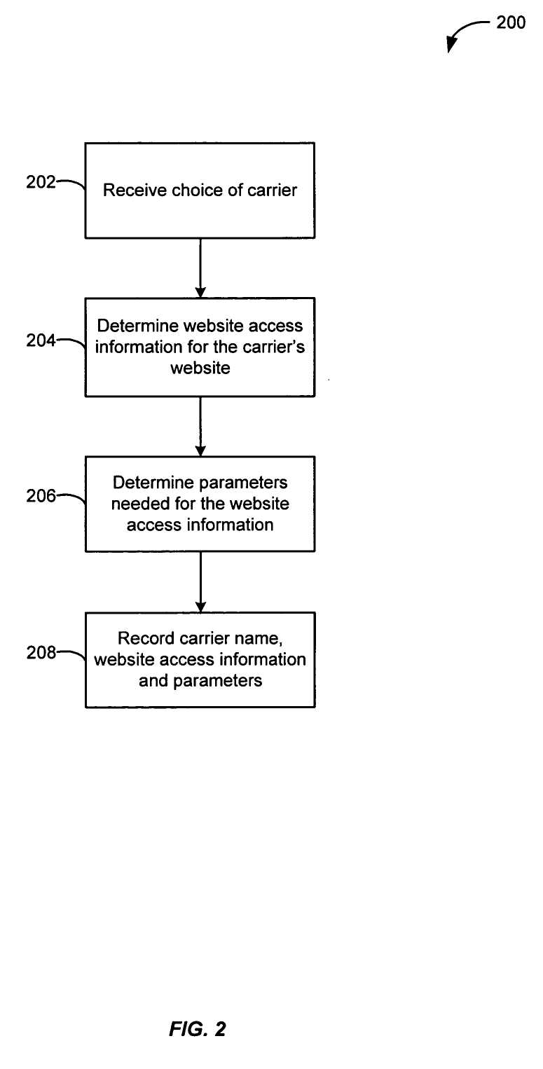

FIG. 2 depicts a simplified flowchart 200 of a method for setting up a tracking service for a carrier 106 according to one embodiment of the present invention. This method may be performed for any number of carrier websites 106.

In step 202, a choice of a carrier is received. The choice may be any information used to identify a carrier's website 106. For example, the name of the carrier, such as UPS, may be provided. Shipment tracker 104 may then determine the carrier's website 106. For example, shipment tracker 104 may determine that a UPS website is found at a certain URL.

In step 204, website access information for the carrier's website 106 is determined. Website access information is any information that is needed for a carrier's website 106 in order to determine tracking status information. For example, website access information may be a URL to a webpage that is used to determine tracking status information. For example, UPS may have a homepage that provides general information for UPS. Another webpage may be provided that is used to provide tracking status information. Additionally, other website access information may be a tracking identifier. For example, a tracking number may be required to identify the item to track. Other information may be login information, password information, etc.

In one embodiment, shipment tracker 104 may provide interface 110 that guides a user to enter which website access information is needed for a carrier's website 106. For example, interface 110 may indicate that the user should enter the webpage URL for the carrier's website tracking status information page, log in information, password information, etc.

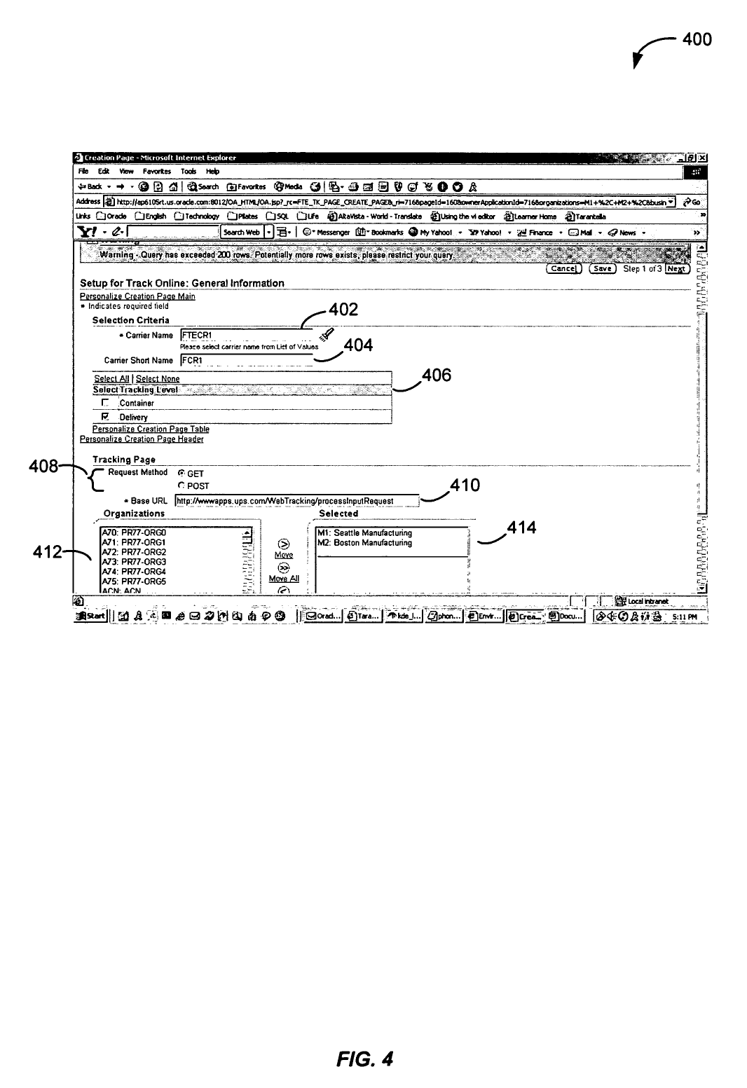

FIG. 4 depicts a graphical user interface 400 for providing information for website access information according to one embodiment of the present invention. As shown, in a first entry area 402, a carrier name may be specified. The carrier name may also be selected from a list of values.

In an entry area 404, a carrier short name may be provided. The short name may be a nickname or shorter name that may be used to refer to the carrier name.

An entry area 406 is provided that allows a user to select a tracking level. A tracking level is the granularity of detail of the shipment tracked. For example, a shipment can tracked either by single unit [Delivery] or individual boxes [Container] within a shipment.

An entry area 408 enables a user to enter a request method for the tracking page. As shown, a method may be get or post. A person skilled in the art will appreciate the get and post request methods, or any other methods. The get and post methods are different methods used to send requests to a website. For example, the post method includes sending parameters using a form. The get method provides the parameters in a URL. After receiving the requests, a website is configured to output a response, such as a webpage with tracking status information.

An entry area 410 allows a user to enter a base URL. The base URL may be a URL for a webpage that is used by a carrier to provide tracking status information.

Entries areas 412 and 414 allow users to specify organizations that may use the carrier for shipment tracking. For example, a company may have many organizations. These organizations may be specified as being able to use this tracking service.

In step 206, the parameters needed for the website access information are determined. For example, the html version, sort by, type of inquiry, location, inquiry number, agree to terms and conditions, etc. may be parameters that are determined. Values for the parameters may also be provided as either constant values or look-up values. For example, constant values are constant provided for the parameters and the value is provided. A look-up parameter may indicate that shipment tracker 104 should look up the parameter at run time. For example, a tracking identifier may be looked up at run time when a tracking status request is received.

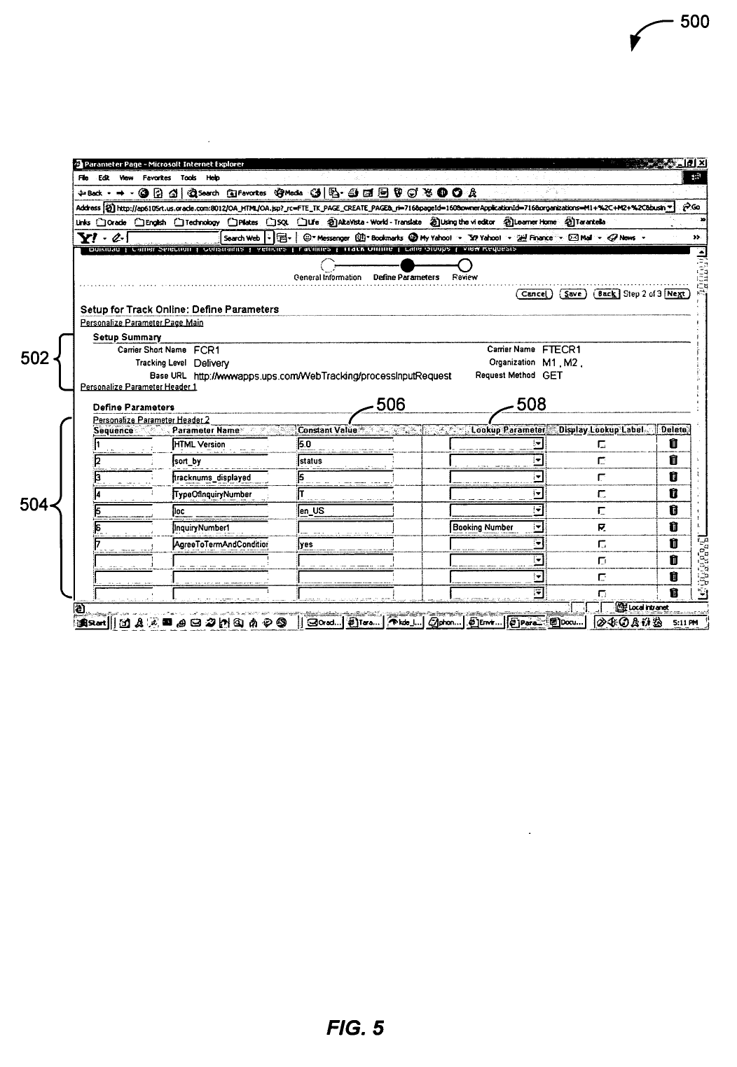

FIG. 5 depicts a graphical user interface 500 that may be provided by shipment tracker 104 according to one embodiment of the present invention. Interface 500 may be used to define parameters for a carrier's website 106. As shown in layout area 502, a summary for a carrier's website is provided. In this case, the carrier's short name (“FCR1”), the carrier name (“FTECR1”), a base URL for the tracking status information webpage, a request method (GET), a tracking level (Delivery), and organization (M1, M2) are provided in a setup summary.

Entry area 504 provides an area where a user may enter parameter information. As shown, the parameters provided are “HTML Version”, “sort_by”, “tracknums_displayed”, “TypeOfInquiryNumber”, “LOC”, “InquiryNumber1”, and “AgreeToTermsAndConditions”. The parameter name “HTML Version” is the version of html used by carrier's website 106. The parameter “sort_by” is how the results should be sorted. The parameter “tracknums_displayed” is the number of tracking numbers that may be inputted on the carrier's webpage. The parameter “TypeOfInquiryNumber” describes the form of the tracking number. For example, “T” is a text inquiry number. The parameter “LOC” is the location of the carrier. The parameter “InquiryNumber1” is the tracking identifier that is needed. For example, this is a unique tracking number. The parameter “AgreeToTermsAndConditions” is a parameter that indicates a user agrees to the terms and conditions needed to track the status of a shipment on a carrier's website 106.

As shown, parameters may be constant values or look-up parameters. Constant values are found in column 506 and look-up parameters are found in column 508. For constant values, a value is inputted in an entry box provided in column 506. For look-up parameters, the variable may be inputted in column 508. In one embodiment, a pull-down menu indicating the variable that should be looked up is provided in column 508.

In step 208, the carrier name, website access information, and parameters are recorded. For example, they may be stored in database 108 under the carrier name. The information stored may then used to track shipments automatically using shipment tracker 104.

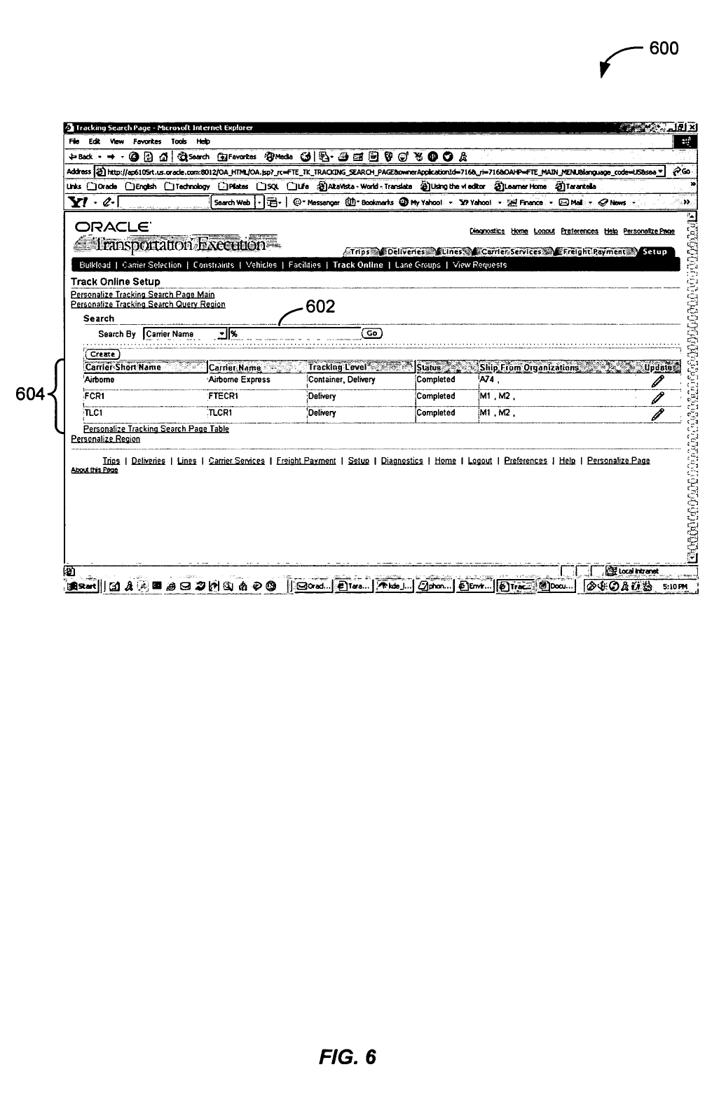

FIG. 6 depicts a graphical user interface 600 that shows a summary of tracking services that have been set up according to one embodiment of the present invention. Interface 600 includes an entry area 602 that may be used to search for carrier tracking services that have been set up. When the search is requested, search results may be provided in layout area 604. As shown, tracking services for three carriers are provided, Airborne Express, FTECR1, and TLCR1. Additionally, information about the carriers is provided, such as a carrier short name, a tracking level, a status, and ship-from organizations. The status is the stage of completion that set up is in. For example, parameters may not have been defined and thus the status may be “not completed, need parameters”.

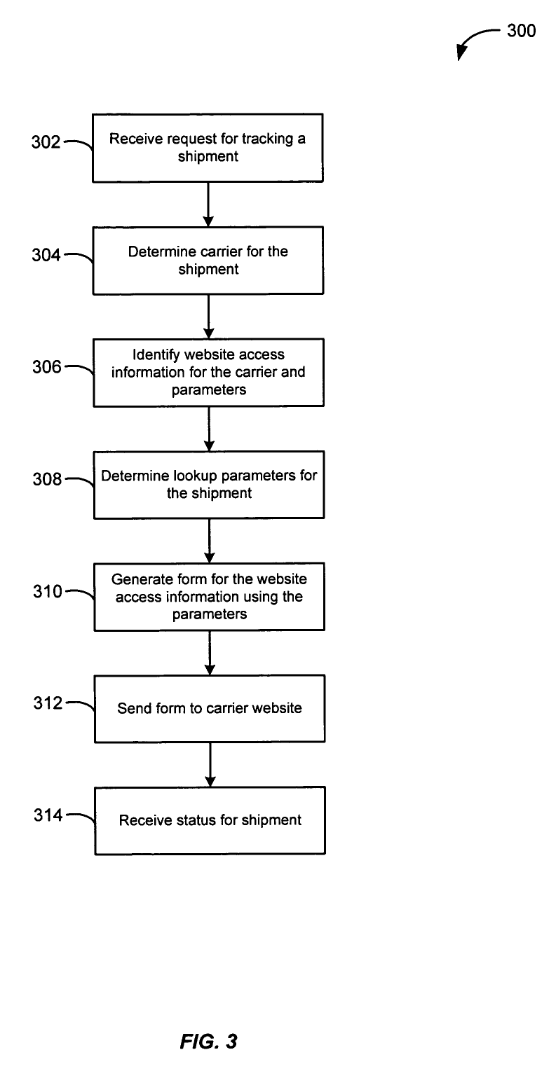

FIG. 3 depicts a simplified flowchart 300 of a method for requesting tracking status information using shipment tracker 104 according to one embodiment of the present invention. In step 302, a request is received for tracking a shipment.

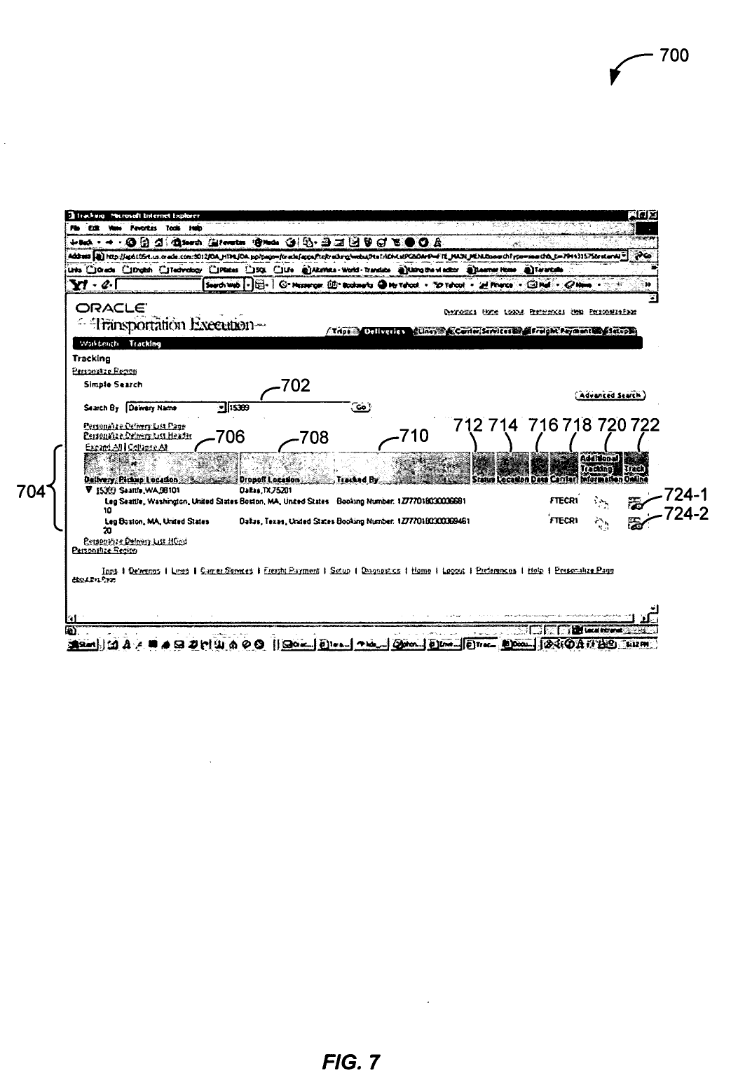

FIG. 7 depicts a graphical user interface 700 that may be used to send a request for tracking a shipment according to one embodiment of the present invention. As shown, an entry area 702 is provided to search for a shipment. As shown, a company tracking identifier has been inputted for a shipment. A layout area 704 is provided that shows a shipment associated with the company tracking identifier. The company tracking identifier is a number that is associated with the shipment and is unique to the company. It may also be the same as a tracking number used by the carrier but this is not necessary.

Other information for the shipment may be provided in layout area 704. For example, in column 706, a pick-up location for the legs of the shipment is shown. In column 708, the drop-off location for the legs of the shipment is shown.

In column 710, tracking identifiers for the carrier are shown. The tracking identifiers are the unique numbers that a carrier uses to identify shipments. These numbers may be different from or be the same as the company's tracking identifiers.

Columns 712, 714, and 716 show the status, location and date. The status may be the status of the shipment for each leg. The location may be the location of the package during the leg and the date may be the date that the package reaches the drop-off location. Column 718 shows the carrier that is associated with the shipment. Column 720 provides any additional tracking information. As shown, an icon is provided that allows a user to select the icon and be provided with additional information.

Column 722 provides an icon 724 for tracking the shipment. A user may select an icon 724 and be automatically provided with tracking status information. Thus, with one click, a user may be provided with tracking status information. It should be noted that the tracking status information is requested using a webpage that is different from the page of the carrier's website 106 that is used to track the status.

In one embodiment, the information provided in entry area 704 is retrieved from database 108. Accordingly, a user only needs to know a company identification number (or a carrier's tracking identifier) for the shipment. Shipment tracker 104 can then retrieve the information needed to access a carrier's tracking status information based on the company tracking identifier. It should be understood that other methods of determining the information provided in entry area 704 may be appreciated.

After receiving the request from a user by selecting icon 724, in step 304, shipment tracker 104 determines a carrier for the shipment. For example, the carrier found in column 718 is determined.

In step 306, any website access information for the carrier is identified along with the applicable parameters. For example, the website access information provided using graphical interface 400 in FIG. 4 in addition to the parameters provided in graphical user interface 500 shown in FIG. 5 are determined. This information is retrieved from database 108.

In step 308, look-up parameters for the shipment are determined. For example, some of the parameters defined may not be constant since they may need to be looked up at run time. For example, a tracking number for the shipment may need to be looked up. As shown, tracking numbers provided in column 710 may be determined.

In step 310, a request, such as a form or URL, for the website access information is generated using the parameters. The request may be a form that is needed by a carrier's website 106 in order to process a tracking status information request. For example, if a get request method is used, then data is passed to carrier website 106 using a URL by using standard HTTP get protocol. If a post request method is used, the request may be passed to carrier website 106 using a form-based request. Other methods of sending requests will be appreciated by a person skilled in the art.

In step 312, the generated request is sent to the carrier website 106. The request is the same request that may be sent to the carrier's website 106 as if a user had manually inputted the information needed to track a status of shipment using the carrier's website 106. If the user uses the carrier's website to manually input the information, an http request may be sent to the carrier's website 106. Accordingly, shipment tracker 104 generates this http request and sends it to the carrier's website 106. This emulates a user manually entering in the tracking status information needed to track a shipment.

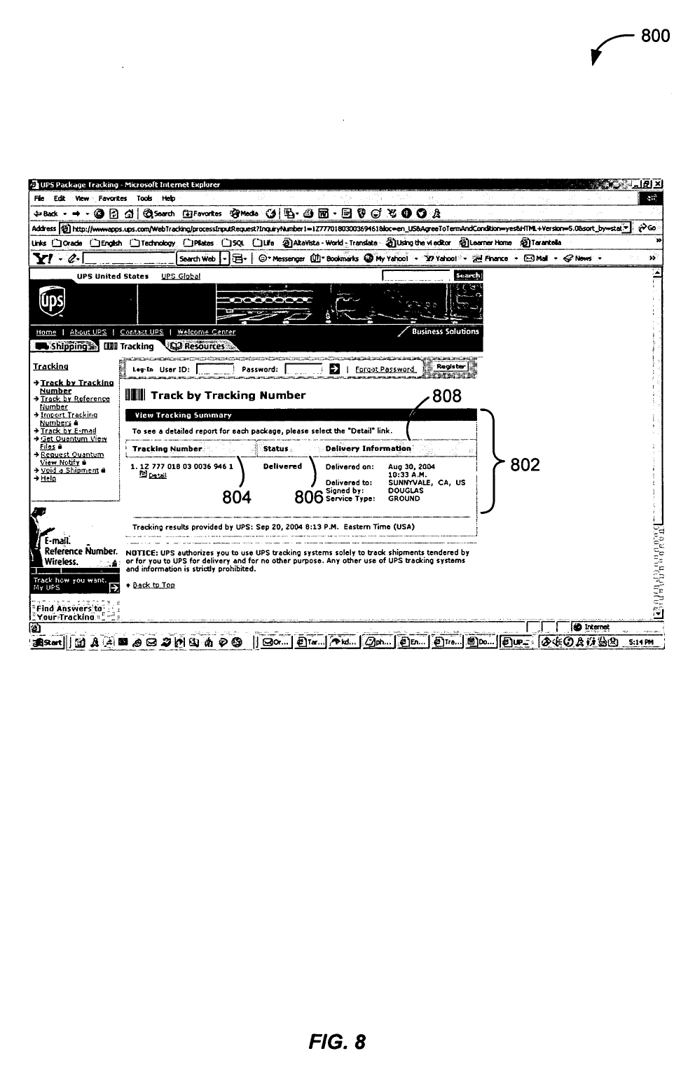

In step 314, status information for the shipment is received. For example, the status information may include any tracking information that is available for the shipment. FIG. 8 shows a graphical user interface 800 that depicts tracking status information that is received from the carrier's website 106 according to one embodiment of the present invention. As shown in entry area 802, tracking status information for a tracking number shown in column 804 is provided. A status shown in column 806 indicates that the package was delivered. Additionally, in column 808, shipment information for the shipment is provided.

Although the above information is provided, it will be understood that other information may be provided. For example, different carriers may provide different status information. However, the status information provided is the same as if a user had manually entered the tracking status information on a carrier's website 106.

Embodiments of the present invention allow integrated capability for business software users to access shipment-tracking information with one click. It allows user to perform a one-time setup to access any third party website. As part of the setup, a user can define the input information third party websites need and where to get that information in the business software database they are using. After the initial setup users can access information from third party websites with a single mouse click.

Embodiments of the present invention interpret the information provided by the user as part of the setup. The process then retrieves the required data elements from database 108 and prepares a request to access the third party website. The user is then presented with the information they requested in a browser window.

Embodiments of the present invention provide many advantages. For example, easy configurability and ease of use is provided. Also, embodiments of the present invention allow one click access to third party websites for shipment tracking. Further, easy configuration by end users to access any third party websites is allowed. Users can change existing carrier configurations and add new carrier configurations without hiring expensive technical consultants. Businesses can save thousands of dollars they had to spend to customize previous solutions to support changing business needs. The solutions can be used by customer service representatives of the company and their direct customers. Other business applications modules can be integrated with this solution using the data driven integration process.

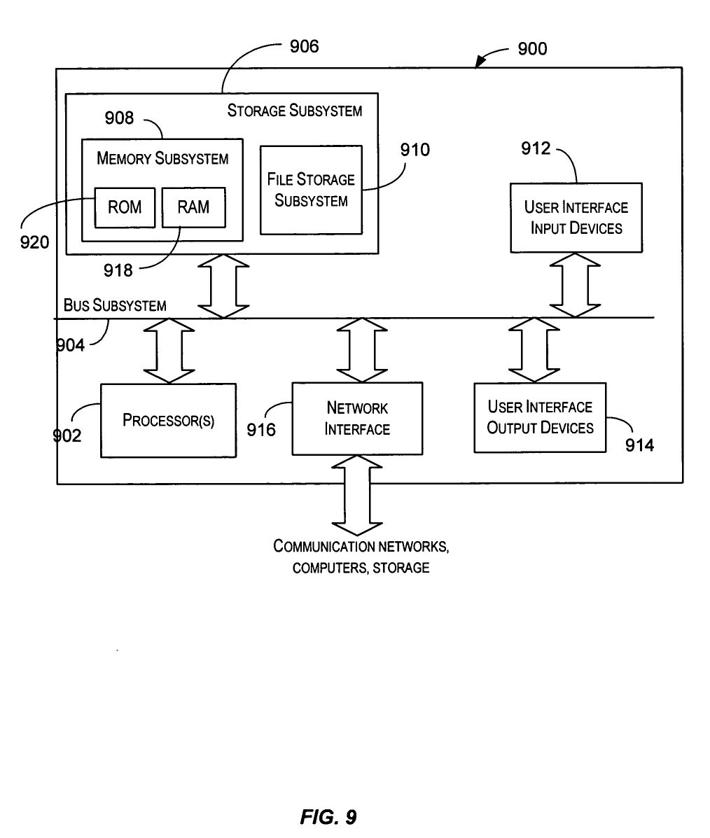

FIG. 9 is a simplified block diagram of a computer system 900 according to an embodiment of the present invention. Embodiments of the present invention may be implemented using computer system 900. As shown in FIG. 9, computer system 900 includes at least one processor 902, which communicates with a number of peripheral devices via a bus subsystem 904. These peripheral devices may include a storage subsystem 906, comprising a memory subsystem 608 and a file storage subsystem 910, user interface input devices 912, user interface output devices 614, and a network interface subsystem 916. The input and output devices allow user interaction with computer system 900. A user may be a human user, a device, a process, another computer, or the like. Network interface subsystem 916 provides an interface to other computer systems and communication networks.

Bus subsystem 904 provides a mechanism for letting the various components and subsystems of computer system 900 communicate with each other as intended. The various subsystems and components of computer system 900 need not be at the same physical location but may be distributed at various locations within a network. Although bus subsystem 604 is shown schematically as a single bus, alternative embodiments of the bus subsystem may utilize multiple busses.

User interface input devices 912 may include a remote control, a keyboard, pointing devices, a mouse, trackball, touchpad, a graphics tablet, a scanner, a barcode scanner, a touchscreen incorporated into the display, audio input devices such as voice recognition systems, microphones, and other types of input devices. In general, use of the term “input device” is intended to include all possible types of devices and ways to input information using computer system 900.

User interface output devices 914 may include a display subsystem, a printer, a fax machine, or non-visual displays such as audio output devices. The display subsystem may be a cathode ray tube (CRT), a flat-panel device such as a liquid crystal display (LCD), a projection device, or the like. The display subsystem may also provide non-visual display such as via audio output devices. In general, use of the term “output device” is intended to include all possible types of devices and ways to output information from computer system 600.

Storage subsystem 906 may be configured to store the basic programming and data constructs that provide the functionality of the computer system and of the present invention. For example, according to an embodiment of the present invention, software modules implementing the functionality of the present invention may be stored in storage subsystem 906. For example, modules implementing the functionality of shipment tracker 104 may be provided. These software modules may be executed by processor(s) 902. In a distributed environment, the software modules may be stored on a plurality of computer systems and executed by processors of the plurality of computer systems. Storage subsystem 906 may also provide a repository for storing various databases that may be used by the present invention. Storage subsystem 906 may comprise memory subsystem 908 and file storage subsystem 910.

Memory subsystem 908 may include a number of memories including a main random access memory (RAM) 918 for storage of instructions and data during program execution and a read only memory (ROM) 920 in which fixed instructions are stored. File storage subsystem 910 provides persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media. One or more of the drives may be located at remote locations on other connected computers.

Computer system 900 itself can be of varying types including a personal computer, a portable computer, a workstation, a computer terminal, a network computer, a mainframe, a kiosk, a personal digital assistant (PDA), a communication device such as a cell phone, or any other data processing system. Server computers generally have more storage and processing capacity then client systems. Due to the ever-changing nature of computers and networks, the description of computer system 900 depicted in FIG. 6 is intended only as a specific example for purposes of illustrating the preferred embodiment of the computer system. Many other configurations of a computer system are possible having more or fewer components than the computer system depicted in FIG. 9.

The present invention can be implemented in the form of control logic in software or hardware or a combination of both. The control logic may be stored in an information storage medium as a plurality of instructions adapted to direct an information processing device to perform a set of steps disclosed in embodiment of the present invention. Based on the disclosure and teachings provided herein, a person of ordinary skill in the art will appreciate other ways and/or methods to implement the present invention.

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method for tracking deliveries of items, the method comprising:
providing an interface for setting up a tracking service for a carrier;
receiving website access information for a website for the carrier;
receiving parameters for the website access information; and
storing the website access information and the parameters for the carrier tracking service,
wherein the website access information and the parameters are used to automatically access tracking information for a shipment for the carrier's website.

2. The method of claim 1, further comprising:
receiving a request for tracking status information for a shipment associated with the carrier; and
automatically generating a status request based on the website access information and the parameters stored for the carrier.

3. The method of claim 2, further comprising receiving tracking status information for the shipment in response to the status request.

4. The method of claim 1, wherein the website access information comprises information determined from a web page for the carrier configured to receive requests for tracking status.

5. The method of claim 1, wherein the parameters comprise information needed for a request for a tracking status for the carrier's website.

6. The method of claim 1, wherein the request comprises a URL generated using the parameters.

7. The method of claim 1, wherein the request comprises a form, the form including information needed to request tracking information for the carrier's website.

8. A method for requesting tracking information, the method comprising:
(a) receiving a request for tracking status information for a shipment associated with a carrier;
(b) determining website access information for a website of the carrier;
(c) determining one or more parameters for the website access information;
(d) generating a request for the website access information using the one or more parameters and information for the shipment;
(e) sending the request to the carrier's website; and
(f) receiving tracking status information in response to sending the request.

9. The method of claim 8, wherein the request is received from a website different from the carrier's website.

10. The method of claim 8, wherein (b)-(f) are performed automatically in response to receiving the request.

11. The method of claim 8, wherein the request is sent using a single selection, wherein the tracking status information is received in response to the single selection.

12. The method of claim 8, wherein the information for the shipment comprises a unique tracking number for the shipment.

13. The method of claim 8, wherein a parameter in the one or more parameters comprises a look up parameter determined after the request is received.

14. The method of claim 8, wherein the website access information comprises information a web page for the carrier configured to receive requests for tracking status.

15. The method of claim 8, wherein the one or more parameters comprise information needed for a request for a tracking status for the carrier.

16. The method of claim 8, wherein the request comprises a URL generated using the one or more parameters and the information for the shipment.

17. The method of claim 8, wherein the request comprises a form, the form including information needed to request the tracking status information from the carrier's website.

18. An information storage medium having a plurality of instructions adapted to direct an information processing device to perform a set of steps for tracking deliveries of items, the steps including:
providing an interface for setting up a tracking service for a carrier;
receiving website access information for a website for the carrier;
receiving parameters for the website access information; and
storing the website access information and the parameters for the carrier tracking service,
wherein the website access information and the parameters are used to automatically access tracking information for a shipment for the carrier's website.

19. The information storage medium of claim 18, further comprising:
receiving a request for tracking status information for a shipment associated with the carrier; and
automatically generating a status request based on the website access information and the parameters stored for the carrier.

20. The information storage medium of claim 19, further comprising receiving tracking status information for the shipment in response to the status request.

21. An information storage medium having a plurality of instructions adapted to direct an information processing device to perform a set of steps for tracking deliveries of items, the steps including: (a) receiving a request for tracking status information for a shipment associated with a carrier;
(b) determining website access information for a website of the carrier;
(c) determining one or more parameters for the website access information;
(d) generating a request for the website access information using the one or more parameters and information for the shipment;
(e) sending the request to the carrier's website; and
(f) receiving tracking status information in response to sending the request.

22. The information storage medium of claim 21, wherein the request is received from a website different from the carrier's website.

23. The information storage medium of claim 21, wherein (b)-(f) are performed automatically in response to receiving the request.

24. The information storage medium of claim 21, wherein the request is sent using a single selection, wherein the tracking status information is received in response to the single selection.
